(19) United States
(12) Patent Application Publication
(10) Pub. No.: US 2026/0162855 A1
(43) Pub. Date: Jun. 11, 2026

(54) ELECTRICAL INSULATION SOCKET AND METHOD FOR INSTALLATION THEREOF

(71) Applicant: SP & LE Enterprises Pty Ltd., New South Wales (AU)

(72) Inventors: Scott Phillips, New South Wales (AU); Lachlan Ermers, New South Wales (AU)

(21) Appl. No.: 18/707,903

(22) PCT Filed: Nov. 7, 2022
(86) PCT No.: PCT/AU2022/051330

§ 371 Date: May 7, 2024

(30) Foreign Application Priority Data
Nov. 7, 2021 (AU) 2021903556

(51) Int. Cl. H01B 17/56

(52) U.S. Cl. CPC H01B 17/56

(57) ABSTRACT

The present invention relates to, in a first aspect, an electrical insulation socket comprising a base portion having an injection aperture extending therethrough to an underside thereof, at least one body portion comprising a tubular body, and an upper portion comprising a socket opening and a peripheral flange, wherein the base, at least one body and upper portions are able to interconnect to form the electrical insulation socket, the at least one body portion forming a socket body, with the flange at an upper end thereof and the base comprising the injection aperture at a lower end thereof. Also included are a guide tool for installation, a method of installation and an electrical insulation socket installation kit.

### PRIORITY DETAILS

The present application claims priority from AU 2021903556, filed in Australia on 7 Nov. 2021, the entirety of which is incorporated herein by reference.

### TECHNICAL FIELD

The present invention relates generally to the field of an electrical insulation socket that can be used to electrically shield an installation to prevent a person from being electrocuted.

### BACKGROUND

Proper electrical protection of an installation requires that, at the very minimum, three elements of the installation be properly shielded to prevent a person from being electrocuted. These three elements are:
a. Any powered equipment;
b. Any conductive material that is handled, manipulated or contacted by the powered equipment; and
c. Anything extraneous and conductive that would be within reach of a person who is simultaneously in contact with either of the above.

By way of non-limiting example, a swimming pool is typically surrounded by fencing, may have a ladder and/or diving board, and employs at the very least a pump/filtration system. The pump/filtration system, being powered, is clearly in need of proper electrical shielding. Similarly, the pool water typically has a range of chemicals dissolved into it, and so is highly conductive—and as it is processed and pumped by the system, the pool must also be appropriately shielded. However, for proper electrical safety it is insufficient to merely apply electrical protection to the pump/filtration system and the swimming pool, but should rather be extended to include the extraneous (but unpowered) structural elements such as the fencing or ladder. This is despite the extraneous structural elements having no electrical communication with the pump/filtration system—these may provide an alternate electrical grounding pathway for the electrical fault to ground by travelling through a person simultaneously contacting the structural element and the pump/filtration system or the swimming pool.

One method of proper electrical protection comprises connecting at least all three elements of the installation to the same earthing grid-this is referred to as equipotential bonding. For many years, equipotential bonding has been one of the primary methods of minimising these risks. The earthing grid provides an optimum ‘path of least resistance’ for ‘leaking’ electricity (such as from an electrical fault) to be earthed, minimising the amount of electricity that will pass through a comparatively electrically-resistant person.

However, the earthing grid can suffer damage, particularly to the connective wires between the disparate elements-for example, earthworks (such as during renovations) may damage the connections. Earthing grids can also be difficult to retrofit or expand. Finally, connection to an earthing grid requires specialist training to ensure that it is done correctly and must be done during installation, meaning that a number of different specialist trades need to be present on site at the same time-potentially causing scheduling issues, as well as slowing construction and increasing costs thereof.

In recent years there has been movement away from equipotential bonding, and the use of powder coatings on extraneous conductive parts such as stainless-steel pool fence spigots has gained favour as a method of electrically insulating the conductive material. However, the powder coating is susceptible to damage through simple wear and tear, chemical process or mechanical damage. Damage to the powder-coat layer again exposes the conductive material underneath, and without proper grounding the exposed conductive material may represent a danger to people nearby. Powder coating also prevents the use of popular finishes such as Polished Stainless Steel or Brushed Stainless Steel.

There is therefore a need for alternate forms of providing electrical protection that can supplement or even replace the prior art methods.

### DISCLOSURE OF THE INVENTION

In a first aspect, the present invention may lie in an electrical insulation socket comprising a base portion having an injection aperture extending therethrough to an underside thereof, at least one body portion comprising a tubular body, and an upper portion comprising a socket opening and a peripheral flange, wherein the base, at least one body and upper portions are able to interconnect to form the electrical insulation socket, the at least one body portion forming a socket body, with the flange at an upper end thereof and the base comprising the injection aperture at a lower end thereof.

In an embodiment, the flange comprises one or more venting apertures extending therethrough, the electrical insulation socket is adapted to be received within a hole bored, reamed, drilled or otherwise formed into a substrate, and the one or more venting apertures are arranged to be positioned over a void formed between an outer surface of the socket body and a wall of the hole.

In an embodiment, the electrical insulation socket is formed to provide fluid communication between the void and the underside end of the injection aperture. In a further embodiment, a socket body length of the formed electrical insulation socket, being from the underside of the base to proximal an underside surface of the flange, is configured to be less than a depth of the hole.

In an embodiment, the base portion is adapted to provide a gap, channel or space along the underside, said gap, channel or space extending from proximal the injection aperture towards an outer edge of the underside.

In an embodiment, an outer, lower edge of the base is chamfered, bevelled, rounded or otherwise sloped or softened.

In an embodiment, the base portion and an upper section of the at least one body portion both comprise a connection means, and the upper portion and a lower section of the at least one body portion both comprise a complementary connection means being connectable to the connection means.

In an embodiment, the base portion and one of the at least one body portions are formed together as a base body portion, an upper section thereof comprising a connection means, and the upper portion comprises a complementary connection means being connectable to the connection means.

In an embodiment, the base portion comprises a connection means, and the upper portion and one of the at least one body portions are formed together as an upper body portion, a lower section thereof comprising a complementary connection means connectable to the connection means.

In an embodiment, the base portion and one of the at least one body portions are formed together as a base body portion, an upper section thereof comprising a connection means, and the upper portion and an alternate one of the at least one body portions are formed together as an upper body portion, a lower section thereof comprising a complementary connection means connectable to the connection means.

In an embodiment, a further one of the at least one body portion comprises connection means at an upper section thereof and complementary connection means at a lower section thereof.

In an embodiment, one of the connection means and complementary connection means comprises male screw thread, and the other of the connection means and complementary connection means comprises female screw thread.

In an embodiment, one of the connection means and complementary connection means comprises a laterally extending pin, and the other of the connection means and complementary connection means comprises a slot arranged to securely receive the laterally extending pin therewithin.

In an embodiment, an inner surface of the socket body comprises at least one support protrusion.

In an embodiment, the electrical insulation socket is substantially formed of a non-electrically-conductive structural material selected from plastic, rubbers, glasses and fibre glasses, non-plastic polymer solids, fibre-reinforced polymers, structural or construction ceramics, and other non-conductive structural composites. In a further embodiment, the non-electrically-conductive structural material is a plastic, and more particularly is a polyamide-based plastic.

A second aspect of the invention may lie in a guide tool for guiding installation of an electrical insulation socket of an embodiment of the first aspect into a substrate, the guide tool comprising a substantially flat underside surface arranged to rest against the substrate, one or more upper surfaces arranged to receive a mass, clamp or other means of restraining the guide tool in position against the substrate, a guide aperture extending from the underside surface and completely through the guide tool, and a guide rim recessed into the periphery of the guide aperture on the underside surface, the guide rim being shaped to receive the flange of the electrical insulation socket therein.

In an embodiment, the guide tool may further comprise a drill guide insert having a drill guide aperture, wherein the drill guide insert is configured to be inserted into the guide aperture from underneath and interfit within the guide rim.

In an embodiment being used to guide installation of an electrical insulation socket having a flange comprising one or more venting apertures extending therethrough, the guide aperture and guide rim are further shaped to receive the flange of the electrical insulation socket therein without occluding any of the one or more venting apertures.

In an embodiment, the one or more upper surfaces of the guide tool are arranged and adapted so that a user restrains the guide tool in position by placing their feet thereupon.

A third aspect of the invention may lie in a method of installing an electrical insulation socket into a substrate, comprising the steps of:
1. providing a guide tool comprising a substantially flat underside surface, one or more upper surfaces arranged to receive a restraining means, a guide aperture and a guide rim recessed into the periphery of the guide aperture on the underside surface;
2. laying the guide tool against the substrate so that the underside surface abuts thereagainst, and restraining the guide tool in place;
3. boring, reaming, cutting or otherwise forming a hole having a predetermined diameter and depth into the substrate, using the guide aperture to position the hole;
4. assembling the electrical insulation socket to comprise a base portion having a base with an injection aperture extending therethrough, at least one body portion, and an upper portion comprising an upper tube section having a flange at an upper end thereof;
5. lifting up, removing or otherwise manoeuvring the guide tool away from the substrate;
6. placing the electrical insulation socket into the hole such that a void forms between the outer surface of the socket body and a wall of the hole, and the flange rests on top of a periphery of the hole;
7. replacing the guide tool in position against the substrate, such that the flange of the electrical insulation socket is received within the guide rim, and again restraining the guide tool in place;
8. injecting a fixing material through the injection aperture in the base of the electrical insulation socket to at least partially fill the void; and
9. removing the restraint from the guide tool and subsequently removing the guide tool from atop the installed electrical insulation socket.

In an embodiment, the hole depth is greater than or equal to a socket body length of the formed electrical insulation socket, and the hole diameter is predetermined so as to be greater than a socket body diameter, and the electrical insulation socket is adapted to, when it is placed into the hole, provide fluid communication between the injection aperture and the void.

In an embodiment, either the base portion and one of the at least one body portions are formed together as a base body portion, one of the at least one body portions and the upper portion are formed together as an upper body portion, or both.

In an embodiment, the flange comprises one or more venting apertures extending therethrough, the guide tool is adapted such that the flange is able to be received within the guide rim without occluding the one or more venting apertures, and the step of placing the electrical insulation socket into the hole includes arranging the socket within the hole such that at least one of the one or more venting apertures opens into the void.

In an embodiment, the guide tool may further comprise a drill guide insert having a drill guide aperture, and the method comprises the additional steps of: prior to the step of laying the guide tool against the substrate, inserting the drill guide insert into the guide aperture of the guide tool so that the drill guide insert interfits within the guide rim; and prior to the step of replacing the guide tool in position against the substrate, removing the drill guide insert from within the guide aperture.

In an embodiment, the electrical insulation socket is an electrical insulation socket of an embodiment of the first aspect of the invention.

In an embodiment, the guide tool is a guide tool of an embodiment of the second aspect of the invention.

A fourth aspect of the invention may lie in an electrical insulation socket installation kit comprising a base portion having an injection aperture extending therethrough to an underside thereof, at least one body portion comprising a tubular body, an upper portion comprising a socket opening and a peripheral flange, and a guide tool comprising a substantially-flat underside surface arranged to rest against substrate that the electrical insulation socket is being installed into, one or more upper surfaces arranged to receive a mass, clamp or other means of restraining the guide tool in position against the substrate, a guide aperture extending from the underside surface and completely through the guide tool, and a guide rim, shaped to receive the flange of the electrical insulation socket, recessed into the periphery of the guide aperture on the underside surface.

In an embodiment, either the base portion and one of the at least one body portions are formed together as a base body portion, one of the at least one body portions and the upper portion are formed together as an upper body portion, or both.

In an embodiment, the kit may further comprise at least one drill guide insert having a drill guide aperture, the drill guide insert being configured to be inserted into the guide aperture of the guide tool from underneath and interfit within the guide rim.

In an embodiment, the electrical insulation socket is an electrical insulation socket of an embodiment of the first aspect of the invention.

In an embodiment, the guide tool is a guide tool of an embodiment of the second aspect of the invention.

Further embodiments of the above aspects of the invention may be disclosed herein or may otherwise become obvious to the person skilled in the art through the disclosure contained herein. These and other embodiments are considered to fall within the scope of the invention.

### DESCRIPTION OF FIGURES

Non-limiting embodiments of the present invention will now be described in relation to figures, wherein:

FIG. 1 depicts an embodiment of the electrical insulation socket in an exploded formation;

FIG. 2 depicts an embodiment of the electrical insulation socket being installed into substrate;

FIG. 3 depicts an embodiment of a base portion of the electrical insulation socket;

FIG. 4 depicts an embodiment of the electrical insulation socket in an exploded formation;

FIG. 5 depicts an embodiment of the electrical insulation socket in an assembled formation;

FIG. 6 depicts embodiments of an upper body portion and a base body portion of the electrical insulation socket;

FIG. 7 depicts an alternate embodiment of the base portion and upper portion of the electrical insulation socket;

FIG. 8 depicts a section view of FIG. 5;

FIG. 9 depicts an embodiment of the guide tool; and

FIGS. 10A & 10B depict an embodiment of the guide tool being used to install an embodiment of the electrical insulation socket.

### DETAILED DESCRIPTION OF PREFERRED EMBODIMENTS

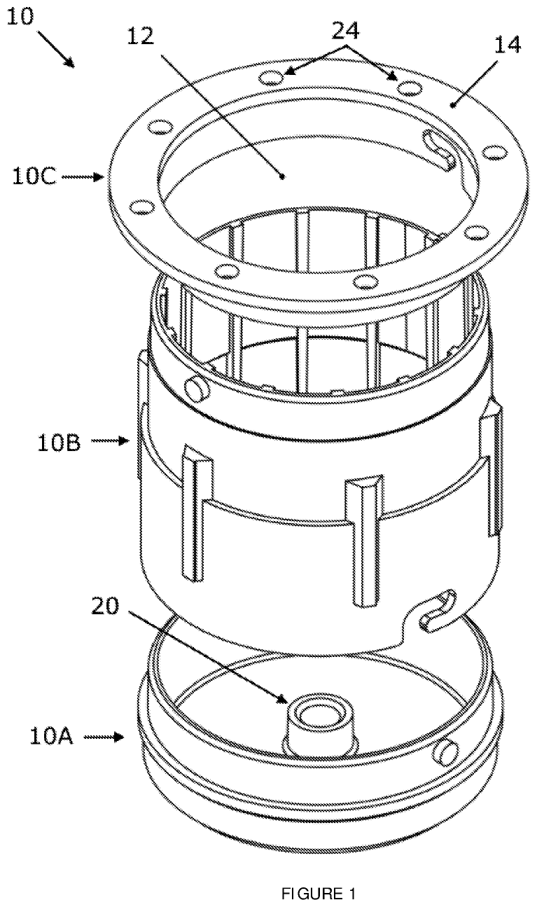

In a first aspect and with reference to FIG. 1, the present invention may lie in an electrical insulation socket 10 comprising a base portion 10A, at least one body portion 10B comprising a tubular body, and an upper portion 10C comprising a socket opening 12 and a peripheral flange 14. In an embodiment, the base portion 10A, at least one body portion 10B and the upper portion 10C are able to interconnect to form the electrical insulation socket, such that the at least one body portion 10B forms the body of the electrical insulation socket 10, with the flange 14 at an upper end thereof.

The skilled person will appreciate that orientation terms such as “upper” and “lower” are used herein for convenience, and to be interpreted as establishing the positioning of elements of the invention relative to one another and with reference to how the invention is depicted in the figures. Unless otherwise explicitly stated, terms such as “upper” and “lower” are not to be construed as limiting the invention to being used, installed or otherwise worked in a specific orientation with respect to the surrounding environment.

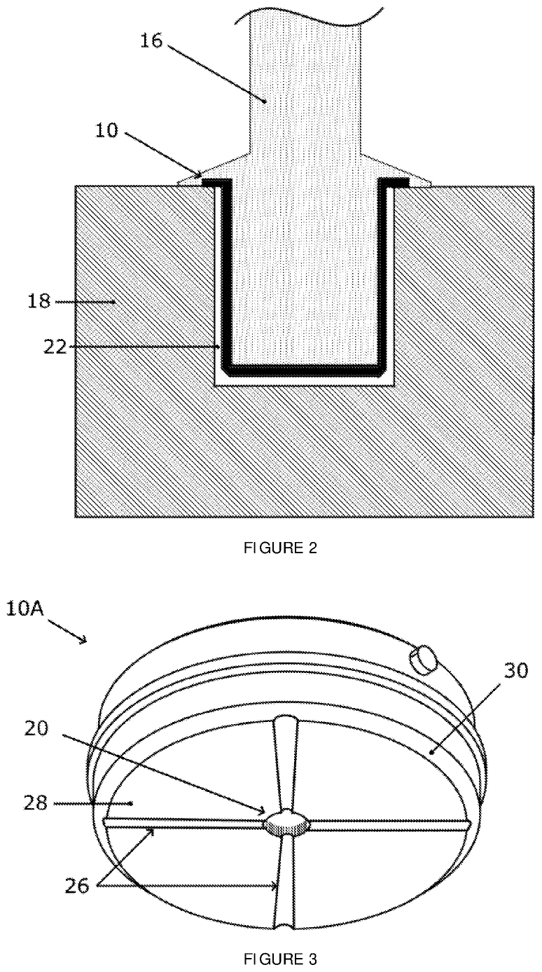

In at least the present embodiment and with reference to FIG. 2, the electrical insulation socket 10 is adapted to be used in the installation of structural element 16 comprising a conductive structural element that is embedded into a substrate 18 as part of the installation process. By way of non-limiting example, one such structural element 16 may be a steel fencepost which is installed by sinking a lower end thereof into substrate 18. The substrate 18 may be concrete, ground material, a sand pad or any other material, and the skilled person will appreciate that the present invention is not limited to use in a specific substrate material.

Returning to the non-limiting example, instead of embedding the lower end of the structural element 16 directly into the substrate, the electrical insulation socket 10 is placed into the substrate 18 first and the structural element 16 installed therewithin. The electrical insulation socket 10 extends from the top of the substrate 18 for at least the length of the embedded portion of the structural element 16, so that no portion of the structural element is directly in contact with the substrate. Without limiting the scope of the invention through theory, it is envisaged that an embodiment of the electrical insulation socket 10, when correctly installed, can effectively reduce, inhibit or otherwise ameliorate the ability for electricity to travel between the fencepost and the substrate. It is further envisaged that this may effectively isolate the embedded portion of the structural element 16 from being able to ground itself, thereby ameliorating the need for equipotential bonding through a common earthing grid or using a powder coating.

It is further envisaged that at least the present embodiment of the electrical insulation socket 10 may be advantageous in that it provides flexibility in installation of structures and other extraneous features. The need to account for damage in the common earthing grid is negated or otherwise ameliorated, installation is greatly simplified as there is less need for multiple specialised trades to be simultaneously on site, and add-ons or expansions may be installed at a later date using the present invention without significant earthworks and electrical planning around an existing earthing grid.

In an embodiment and with further reference to FIGS. 1 & 2, the base portion 10A may have an injection aperture 20 extending therethrough. This may enable a fixing material such as resin, plastic cement, epoxy, or any other suitable fixing material, to be injected into a gap or void 22 that is surrounding the positioned electrical insulation socket 10.

In an embodiment, the flange 14 may comprise one or more venting apertures 24 extending therethrough. The one or more venting apertures 24 may be oriented so that, when the electrical insulation socket 10 is received within a hole that is formed into substrate 18, the one or more venting apertures 24 are positioned over a void 22 formed between an outer surface of the socket body and a wall of the hole. The one or more venting apertures 24 may provide a means for air within the void 22 to escape.

In an embodiment, the electrical insulation socket 10 is adapted to, when it is placed into the hole, provide fluid communication between the injection aperture 20 and the void 22. In one further embodiment, a socket body length (measured from the underside of the base to proximal an underside surface of the flange) may be configured to be less than the hole depth, such that there is a gap between the underside and the bottom of the hole for fixing material to flow into. This may enable the injected fixing material to flow around the outer surface of the electrical insulation socket and into the void 22.

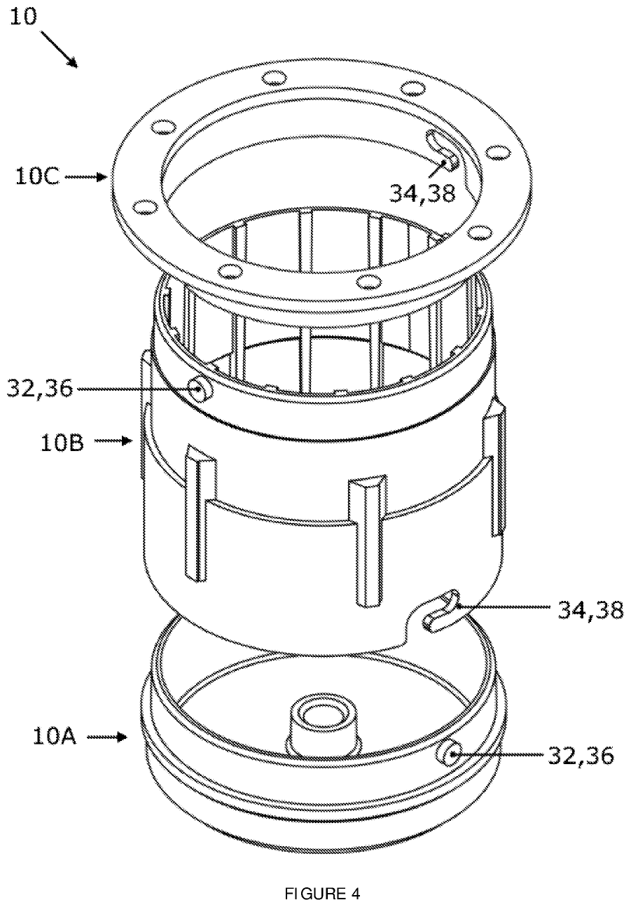

In an alternate further embodiment and with reference to FIG. 3, the base portion 10A may be adapted to provide a gap, channel or space 26 along an underside 28 thereof. The gap, channel or space 26 may extend from proximal to the injection aperture 20 in a direction towards an outer edge 30 of the base portion 10A. The gap, channel or space 26 may extend all the way to an outer edge 30 of the base portion 10A. This further embodiment may be used in addition to, or in place of the previously-discussed further embodiment.

In an embodiment, an outer, lower edge 30 of the base portion 10A may be chamfered, bevelled, rounded or otherwise sloped or softened. This may enable the electrical insulation socket 10 to be inserted into a hole within substrate 18 with greater ease. The outer, lower edge 30 being chamfered, bevelled, rounded or otherwise sloped or softened may also promote or assist in movement of fixing material around the outside of the electrical insulation socket 10 and may therefore enable more even distribution thereof. This may promote the electrical insulation socket 10 being more solidly and securely installed into the substrate. The base portion 10A having a chamfered, bevelled, rounded or otherwise sloped or softened outer, lower edge 30 may be provided in combination with any other embodiment of the base portion described herein unless explicitly mentioned otherwise.

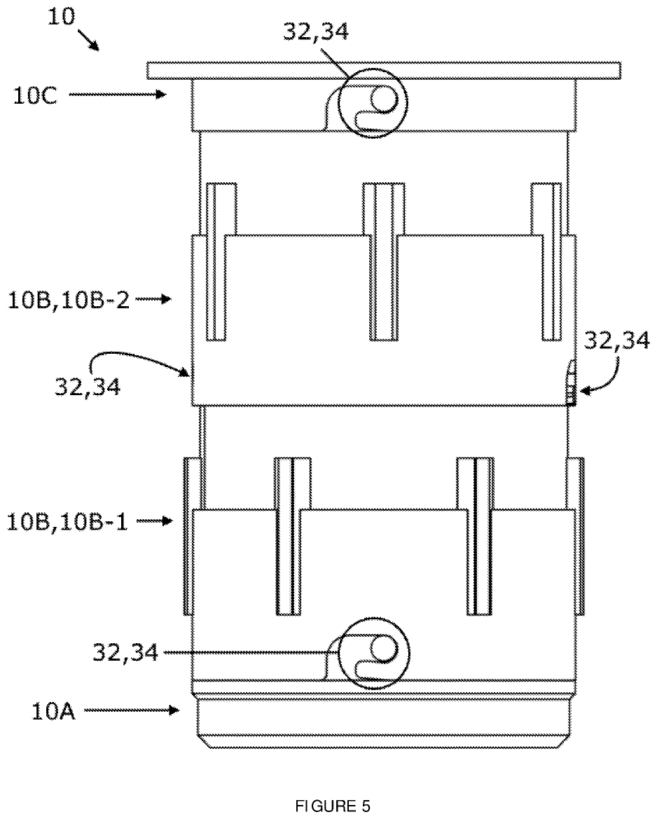

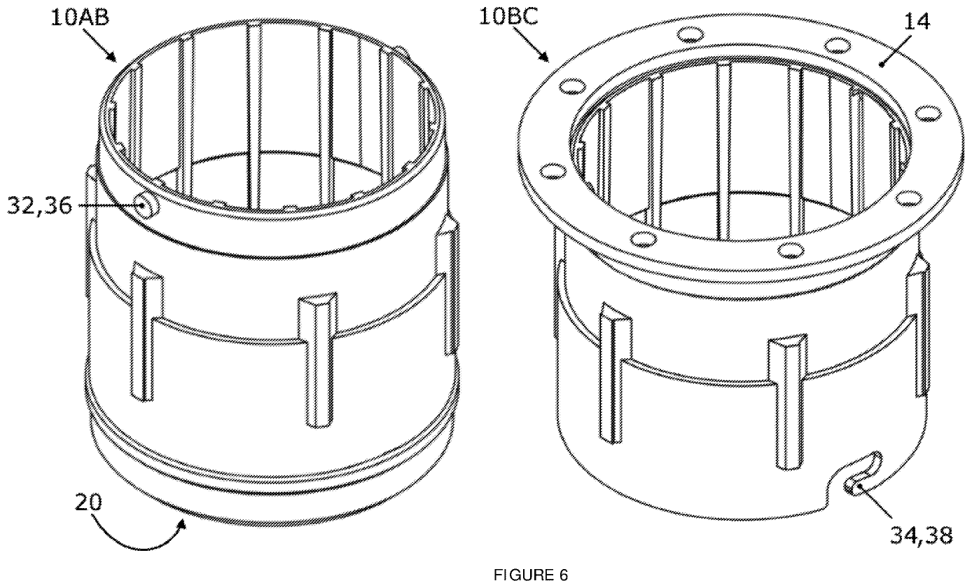

In an embodiment and with reference to FIGS. 4 & 5, the base portion 10A and an upper section of the at least one body portion 10B may both comprise a connection means 32. In an embodiment, the upper portion 10C and a lower section of the at least one body portion 10B may both comprise a complementary connection means 34 that is connectable to the connection means 32. This may enable the base portion 10A, one or more body portions 10B and the upper portion 10C to be able to sequentially interconnect to form the electrical insulation socket 10. FIG. 5 depicts a non-limiting example of such an embodiment, wherein the electrical insulation socket 10 comprises a base portion 10A, a first and second body portion 10B-1, 10B-2, and an upper portion 10C. As the skilled person will appreciate, in such an embodiment the connection means 32 on the base portion 10A is compatible with the complementary connection means 34 both on the upper portion 10C and on the first and second body portions 10B-1, 10B-2, while the complementary connection means 34 on the upper portion 10C is compatible with both the connection means 32 on the base portion 10A and on the first and second body portions 10B-1, 10B-2. It is believed that at least the present embodiment may therefore enable the electrical insulation socket 10 to be modularly adaptable to a range of different socket body lengths by using any number of body portions 10B (or none at all), with the socket body length being dependent upon the needs of the structural element 16 being installed.

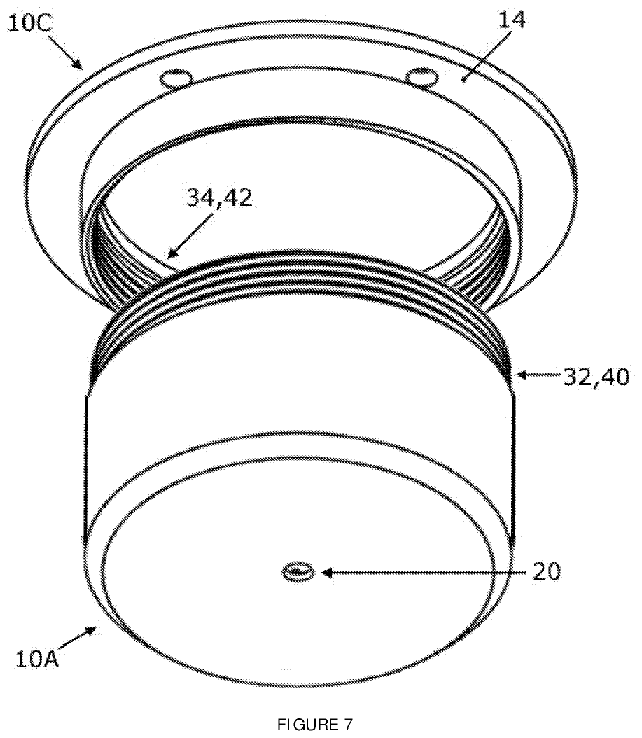

In an embodiment and with reference to FIG. 6, one of the at least one body portions 10B and either the base portion 10A or the upper portion 10C may be formed together as a base body portion 10AB comprising connection means 32, or as an upper body portion 10BC comprising complementary connection means 34, respectively. An embodiment of the electrical insulation socket 10 may comprise either, or both, of the base body portion 10AB and/or the upper body portion 10BC. In a further embodiment, the electrical insulation socket may additionally comprise at least a further one of the at least one body portions 10B, having connection means 32 at an upper section thereof and complementary connection means 34 at a lower section thereof.

In an embodiment and with further reference to FIG. 6, as well as return reference to FIG. 4, one of the connection means 32 and complementary connection means 34 may comprise a laterally extending pin 36, while the other of the connection means and complementary connection means comprises a slot 38 arranged to securely receive the laterally-extending pin therewithin. In a further embodiment, the pin 36 and slot 38 fitting may comprise a bayonet fitting.

In an alternate embodiment and with reference to FIG. 7, one of the connection means 32 and complementary connection means 34 may comprise male screw thread 40, with the other of the connection means and complementary connection means comprising female screw thread 42. FIG. 7 depicts an embodiment of a base portion 10A and an upper portion 10C, however the person skilled in the art will appreciate that the body portion 10B of such an embodiment would comprise similarly-configured connection means 32 and/or complementary connection means 34. The skilled person will further appreciate that alternative forms of the connection means 32 and complementary connection means 34 other than those described herein may be able to be employed without departing from the scope of the invention.

In one preferred embodiment, each connection means 32 is configured to be substantially similar to each other, and each complementary connection means 34 is configured to be substantially similar to each other. This may enable such an embodiment of the electrical insulation socket 10 to be substantially modular, such that body portions 10B may be selectively introduced or removed from the socket body to modularly adjust the length to meet the needs of the user.

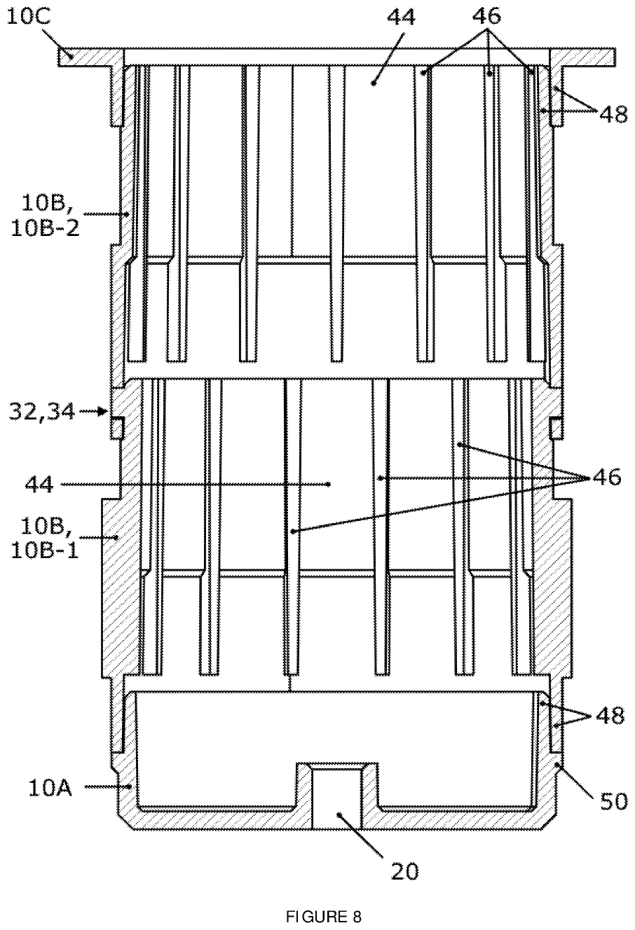

In an embodiment and with reference to FIG. 8, which is a section view of the embodiment of the electrical insulation socket 10 depicted in FIG. 5, an inner surface 44 may comprise at least one support protrusion 46. The at least one support protrusion 46 may aid in secure fixing and installation of a structural element 16 with anchoring cement therewithin. The at least one support protrusion 46 may provide additional surfaces for anchoring cement to adhere or cement onto, thereby promoting a firmer cementing and fixing of the structural element 16 into position.

In an embodiment, the base, body and upper portions 10A, 10B, 10C may each comprise lipped portions 48 that, upon interconnection, overlap one another. In a further embodiment, the lipped portions 48 may be sized to provide a snug fit upon interconnection. In a further embodiment, at least one of the portions 10A, 10B, 10C may comprise a guiding stop 50, such that that adjacent portions overlap each other to the appropriate depth to enable the connection means 32 and complementary connection means 34 to properly engage with and/or connect to one another.

In an embodiment, the electrical insulation socket 10 may be substantially formed of plastic. In a further embodiment, the plastic may be a polyamide-based plastic. In an alternate embodiment, the electrical insulation socket 10 may be formed of any other suitable non-conductive material that is stable relative to the substrate, fixing material and the structural element. Some examples of suitable materials are rubbers (such as vulcanised rubber or other hard rubbers); glasses, including fibre glasses; non-plastic polymer solids, including fibre-reinforced polymers; structural or construction ceramics; and other non-conductive structural composites.

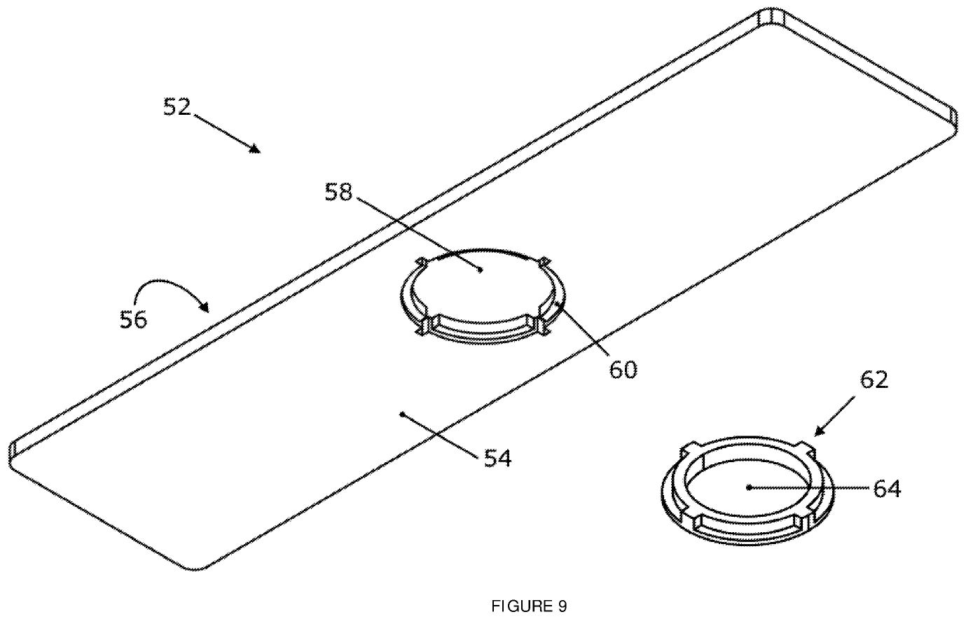

A second aspect of the present invention lies in a guide tool for guiding installation of an electrical insulation socket 10 of an embodiment of the first aspect into a substrate. In an embodiment and with reference to FIG. 9, the guide tool 52 may comprise a substantially-flat underside surface 54 arranged to rest against the substrate, one or more upper surfaces 56 arranged to receive a mass, clamp or other means of restraining the guide tool in position against the substrate, a guide aperture 58 extending from the underside surface and completely through the guide tool, and a guide rim 60 recessed into the periphery of the guide aperture on the underside surface. In a further embodiment, the guide rim 60 may be shaped to receive the flange 14 of the electrical insulation socket 10 therein.

The guide tool 52 may be sized so that a diameter of the guide aperture 58 substantially matches the appropriate diameter of a hole for a given electrical insulation socket 10 having a given socket body diameter. Additionally, the provision of the guide rim 60, which receives the flange 14 of the electrical insulation socket 10, on the underside surface 54 of the guide tool 52, may enable the user to suitably locate and arrange the electrical insulation socket within the hole. In an embodiment, the guide tool 52 may be used to guide installation of an electrical insulation socket 10 having a flange 14 comprising one or more venting apertures 24 extending therethrough. In such an embodiment, the guide aperture 58 and guide rim 60 may be shaped to receive the flange 14 of the electrical insulation socket 10 therein without occluding any of the one or more venting apertures 24.

In an embodiment, the one or more upper surfaces 56 of the guide tool 52 may be arranged so that a user thereof may restrain the guide tool in position by placing their feet upon it.

In an embodiment, the guide tool 52 may further comprise a drill guide insert 62, which is configured to be inserted into the guide aperture 58 from underneath and interfit within the guide rim 60. The drill guide insert 62 may comprise a drill guide aperture 64 that guides the user in drilling, boring, reaming or otherwise forming the hole in the substrate 18. In an embodiment, the diameter of the hole that is to be formed within the substrate 18 by the user is predetermined so that, upon installation of the electrical insulation socket 10 into the hole, a void 22 is formed between the outer surface of the tubular body of the electrical insulation socket and an inner surface of the hole. In a further embodiment, a diameter of the drill guide aperture 64 substantially matches the predetermined diameter of the hole that is to be formed in the substrate 18, such that the drill guide aperture 64 provides a hole size template for the user.

The skilled person will appreciate that the purpose of the void 22 within the hole is to provide space for fixing material to flow into and at least partially fill, so as to bind and fix the installed electrical insulation socket 10 therewithin. The skilled person will further appreciate that the socket body diameter of an electrical insulation socket 10 may vary based upon the size of a structural element 16 that is being installed. As such, to ensure that a void 22 is formed between the outer surface of the tubular body and an inner surface of the hole, electrical insulation sockets 10 having different socket body diameters may require holes of different predetermined diameters. Additionally, it may be practical to ensure that the resulting void 22 is neither so large that an excessive amount of fixing material is required to fill it enough to suitably fix the socket therewithin, nor so small that fixing material either cannot properly flow therethrough or cannot provide adequate fixing. To that end and in an embodiment, the guide tool 52 may comprise a plurality of drill guide inserts 62, each having a guide aperture 64 with a different diameter. Such an embodiment may enable a single guide tool to be used to assist in the installation of electrical insulation sockets 10 having different socket body diameters. Use of different drill guide inserts 62 having a different diameter guide apertures 64 enables the user to provide a hole having an appropriate hole diameter so that the resulting void 22 is of an appropriate size. The skilled person will appreciate that the relationship between socket body diameter and appropriate hole diameter to ensure proper fixing is dependent upon myriad factors, including substrate material, socket body material, socket body length and the type of fixing material to be used.

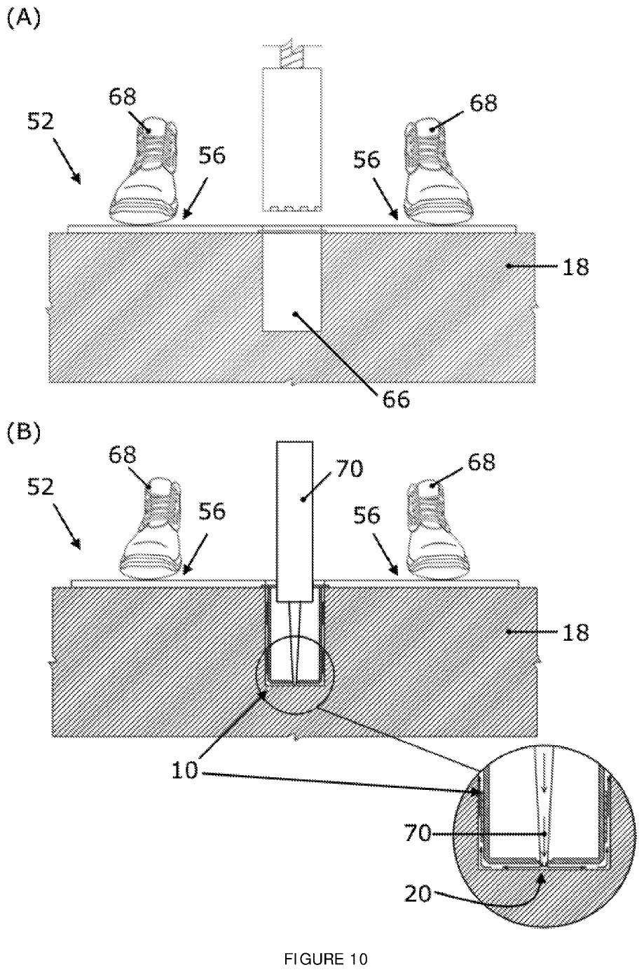

FIGS. 10A & 10B depict an embodiment of the guide tool 52 being used to first drill the hole 66 in substrate 18 and then install an embodiment of the electrical insulation socket 10 therein. In the depicted embodiment, the guide tool 52 is pinned in place by the user's feet 68 being resting upon the one or more upper surfaces 56. In particular, the insert of FIG. 10B depicts injection of a fixing material 70 through the injection aperture 20 in the base of the electrical insulation socket 10.

A third aspect of the present invention may lie in a method of installation of an electrical insulation socket into a substrate. The method may comprise the use of a guide tool comprising a substantially flat underside surface, one or more upper surfaces arranged to receive a restraining means, a guide aperture and a guide rim recessed into the periphery of the guide aperture on the underside surface. The method may comprise the steps of:
1) providing the guide tool;
2) providing a guide tool comprising a substantially flat underside surface, one or more upper surfaces arranged to receive a restraining means, a guide aperture and a guide rim recessed into the periphery of the guide aperture on the underside surface;
3) laying the guide tool against the substrate so that the underside surface abuts thereagainst, and restraining the guide tool in place;
4) boring, reaming, cutting or otherwise forming a hole having a predetermined diameter and depth into the substrate, using the guide aperture to position the hole;
5) assembling the electrical insulation socket to comprise a base portion having a base with an injection aperture extending therethrough, at least one body portion, and an upper portion comprising an upper tube section having a flange at an upper end thereof;
6) lifting up, removing or otherwise manoeuvring the guide tool away from the substrate;
7) placing the electrical insulation socket into the hole such that a void forms between the outer surface of the socket body and a wall of the hole, and the flange rests on top of a periphery of the hole;
8) replacing the guide tool in position against the substrate, such that the flange of the electrical insulation socket is received within the guide rim, and again restraining the guide tool in place;
9) injecting a fixing material through the injection aperture in the base of the electrical insulation socket to at least partially fill the void; and
10) maintaining the restraint of the guide tool in place at least until the fixing material has set and fixes the electrical socket within the hole.

In an embodiment, the electrical insulation socket may comprise either the base portion and one of the at least one body portions being formed together as a base body portion, one of the at least one body portions and the upper portion being formed together as an upper body portion, or both.

In an embodiment, the formed electrical insulation socket may comprise a socket body length less than or equal to the hole depth, and a socket body diameter less than that of the hole diameter. The socket body length may be measured from the underside of the electrical insulation socket base to a point proximal to an underside of the flange.

In an embodiment, the electrical insulation socket may be adapted to, when it is placed into the hole, provide fluid communication between the injection aperture and the void. In one further embodiment, the socket body length may be less than the hole depth, such that there is a gap between the underside and the bottom of the hole for fixing material to flow into. This may enable the injected fixing material to flow around the outer surface of the electrical insulation socket and into the void. In another further embodiment, the base of the electrical insulation socket may be shaped to comprise at least one gap, channel or space along an underside thereof extending from proximal the injection aperture to an outer edge of the base. This may provide fluid communication between the injection aperture and the void. The present embodiment may be in addition to, or instead of, the aforementioned embodiment wherein the socket body length is less than the hole depth.

In an embodiment, the flange of the electrical insulation socket may comprise one or more venting apertures extending therethrough. In such an embodiment, the guide tool may be adapted such that the flange is able to be received within the guide rim without occluding the one or more venting apertures, and the step of placing the electrical insulation socket into the hole may include arranging the socket within the hole such that at least one of the one or more venting apertures opens into the void. This may aid in the injection of fixing material into the hole surrounding the electrical insulation socket, as the venting apertures opening into the void between the hole wall and the outer surface of the socket body may enable air located therewithin to escape.

In an embodiment, the guide tool may be adapted to be able to be restrained in place by the user standing, kneeling or otherwise positioning themselves atop the guide tool. This may be in addition to, or instead of, the user placing a weighted object, a clamping means or some other form of restraining means upon the guide tool. In a further embodiment, the user may be able to stand upon guide tool during any or all of steps 3, 4, & 8-10. The user may alternatively be able to “switch out” with a further user, or may instead be able to place a weighted object, a clamping means or some other form of restraining means upon the guide tool for at least part of any one of steps 3, 4, & 8-10. The skilled person will appreciate that some types of fixing material may have setting times or drying times measured in hours (or more), and so it may be preferable for the user to be able to utilise a weighted object, a clamping means or some other form of restraining means for at least a portion of the duration of step 10, even if they have been restraining the guide tool in place by standing or kneeling thereupon in a previous step.

In an embodiment, the guide tool may further comprise a drill guide insert having a drill guide aperture. In such an embodiment, the method may comprise the additional step of, prior to the step of laying the guide tool against the substrate, inserting the drill guide insert into the guide aperture of the guide tool so that the drill guide insert interfits within the guide rim. The method may further comprise the step of, prior to the step of replacing the guide tool in position against the substrate, removing the drill guide insert from within the guide aperture. In a further embodiment, the drill guide aperture of the drill guide insert may enable the user to drill, ream, bore or otherwise form a hole of appropriate diameter within the substrate such that a void of suitable size is formed between the outer surface of the socket body and the inner surface of the hole and, upon injecting fixing material, said fixing material is able to flow into the formed void.

In an embodiment, the electrical insulation socket may be an embodiment of the electrical insulation socket 10 first aspect of the invention.

In an embodiment, the guide tool may be an embodiment of the guide tool 52 of the second aspect of the invention.

A fourth aspect of the present invention may lie in an electrical insulation socket installation kit comprising a base portion having an injection aperture extending therethrough, at least one body portion comprising a tubular body, an upper portion comprising a socket opening and a peripheral flange, and a guide tool to assist in installation thereof.

In an embodiment, the guide tool may comprise a substantially-flat underside surface arranged to rest against substrate that the electrical insulation socket is being installed into, one or more upper surfaces arranged to receive a mass, clamp or other means of restraining the guide tool in position against the substrate, a guide aperture extending from the underside surface and completely through the guide tool, and a guide rim, shaped to receive the flange of the electrical insulation socket, recessed into the periphery of the guide aperture on the underside surface.

In an embodiment, the kit may further comprise at least one drill guide insert comprising a drill guide aperture, the drill guide insert being designed to be inserted into the guide aperture of the guide tool and interfit with the guide rim. In a further embodiment, the kit may comprise a plurality of drill guide inserts, each having a drill guide aperture with a different diameter.

In an embodiment, the kit may comprise either the base portion and one of the at least one body portions being formed together as a base body portion, one of the at least one body portions and the upper portion being formed together as an upper body portion, or both.

In an embodiment, the electrical insulation socket may be an embodiment of the electrical insulation socket 10 first aspect of the invention.

In an embodiment, the guide tool may be an embodiment of the guide tool 52 of the second aspect of the invention.

In an embodiment, the kit may be adapted to be installed using a method that is an embodiment of the third aspect of the invention.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. An electrical insulation socket comprising:
a base portion having an injection aperture extending therethrough to an underside thereof;
at least one body portion comprising a tubular body; and
an upper portion comprising a socket opening and a peripheral flange;
wherein the base, at least one body and upper portions are able to interconnect to form the electrical insulation socket, the at least one body portion forming a socket body, with the flange at an upper end thereof and the base comprising the injection aperture at a lower end thereof.

2. The electrical insulation socket of claim 1, wherein the flange comprises one or more venting apertures extending therethrough;
further wherein the electrical insulation socket is adapted to be received within a hole bored, reamed, drilled or otherwise formed into a substrate; and
the one or more venting apertures are arranged to be positioned over a void formed between an outer surface of the socket body and a wall of the hole.

3. The electrical insulation socket of claim 2, wherein the electrical insulation socket is formed to provide fluid communication between the void and the underside end of the injection aperture.

4. The electrical insulation socket of claim 3, wherein a socket body length of the formed electrical insulation socket, being from the underside of the base to proximal an underside surface of the flange, is configured to be less than a depth of the hole.

5. The electrical insulation socket of claim 3, wherein the base portion is adapted to provide a gap, underside, said gap, channel or space extending from proximal the injection aperture towards an outer edge of the underside.

6. The electrical insulation socket of claim 1, wherein an outer, lower edge of the base is chamfered, bevelled, rounded or otherwise sloped or softened.

7. The electrical insulation socket of claim 1, wherein:
the base portion and an upper section of the at least one body portion both comprise a connection means; and
the upper portion and a lower section of the at least one body portion both comprise a complementary connection means being connectable to the connection means.

8. The electrical insulation socket of claim 1, wherein:
the base portion and one of the at least one body portions are formed together as a base body portion, an upper section thereof comprising a connection means; and
the upper portion comprises a complementary connection means being connectable to the connection means.

9. The electrical insulation socket of claim 1, wherein: the base portion comprises a connection means; and
the upper portion and one of the at least one body portions are formed together as an upper body portion, a lower section thereof comprising a complementary connection means connectable to the connection means.

10. The electrical insulation socket of claim 1, wherein:
the base portion and one of the at least one body portions are formed together as a base body portion, an upper section thereof comprising a connection means; and
the upper portion and an alternate one of the at least one body portions are formed together as an upper body portion, a lower section thereof comprising a complementary connection means connectable to the connection means.

11. The electrical insulation socket of claim 8, wherein a further one of the at least one body portion comprises connection means at an upper section thereof and complementary connection means at a lower section thereof.

12. The electrical insulation socket of claim 7, wherein one of the connection means and complementary connection means comprises male screw thread; and
the other of the connection means and complementary connection means comprises female screw thread.

13. The electrical insulation socket of claim 7, wherein one of the connection means and complementary connection means comprises a laterally extending pin; and
the other of the connection means and complementary connection means comprises a slot arranged to securely receive the laterally extending pin therewithin.

14. The electrical insulation socket of claim 1, wherein an inner surface of the socket body comprises at least one support protrusion.

15. The electrical insulation socket of claim 1, being substantially formed of a non-electrically-conductive structural material selected from plastic, rubbers, glasses and fibre glasses, non-plastic polymer solids, fibre-reinforced polymers, structural or construction ceramics, and other non-conductive structural com posit es.

16. The electrical insulation socket of claim 15, wherein the non-electrically-conductive structural material is plastic; and
the plastic is a polyamide-based plastic.

17. A guide tool for guiding installation of an electrical insulation socket of claim 1 into a substrate, the guide tool comprising:
a substantially flat underside surface arranged to rest against the substrate;
one or more upper surfaces arranged to receive a mass, clamp or other means of restraining the guide tool in position against the substrate;
a guide aperture extending from the underside surface and completely through the guide tool; and
a guide rim recessed into the periphery of the guide aperture on the underside surface, the guide rim being shaped to receive the flange of the electrical insulation socket therein.

18. The guide tool of claim 17, further comprising a drill guide insert having a drill guide aperture;
wherein the drill guide insert is configured to be inserted into the guide aperture from underneath and interfit within the guide rim.

19. The guide tool of claim 17, when used to guide installation of an electrical insulation socket having a flange comprising one or more venting apertures extending therethrough;
wherein the guide aperture and guide rim are further shaped to receive the flange of the electrical insulation socket therein without occluding any of the one or more venting apertures.

20. The guide tool of claim 17, wherein the one or more upper surfaces of the guide tool are arranged and adapted so that a user restrains the guide tool in position by placing their feet thereupon.

21. A method of installing an electrical insulation socket into a substrate, comprising the steps of:
providing a guide tool comprising a substantially flat underside surface, one or more upper surfaces arranged to receive a restraining means, a guide aperture and a guide rim recessed into the periphery of laying the guide tool against the substrate so that the underside surface abuts thereagainst, and restraining the guide tool in place;
boring, reaming, cutting or otherwise forming a hole having a predetermined diameter and depth into the substrate, using the guide aperture to position the hole;
assembling the electrical insulation socket to comprise a base portion having a base with an injection aperture extending therethrough, at least one body portion, and an upper portion comprising an upper tube section having a flange at an upper end thereof;
lifting up, removing or otherwise manoeuvring the guide tool away from the substrate;
placing the electrical insulation socket into the hole such that a void forms between the outer surface of the socket body and a wall of the hole, and the flange rests on top of a periphery of the hole;
replacing the guide tool in position against the substrate, such that the flange of the electrical insulation socket is received within the guide rim, and again restraining the guide tool in place;
injecting a fixing material through the injection aperture in the base of the electrical insulation socket to at least partially fill the void; and
removing the restraint from the guide tool and subsequently removing the guide tool from atop the installed electrical insulation socket;
wherein the hole depth is greater than or equal to a socket body length of the formed electrical insulation socket, and the hole diameter is greater than a socket body diameter; and
the electrical insulation socket is adapted to, when it is placed into the hole, provide fluid communication between the injection aperture and the void.

22. The method of claim 21, wherein either:
the base portion and one of the at least one body portions are formed together as a base body portion; or
one of the at least one body portions and the upper portion are formed together as an upper body portion;
or both.

23. The method of either claim 21, wherein the flange comprises one or more venting apertures extending therethrough;
the guide tool is adapted such that the flange is able to be received within the guide rim without occluding the one or more venting apertures; and
the step of placing the electrical insulation socket into the hole includes arranging the socket within the hole such that at least one of the one or more venting apertures opens into the void.

24. The method of claim 21, wherein the guide tool further comprises a drill guide insert having a drill guide aperture, and the method comprises the additional steps of:
prior to the step of laying the guide tool against the substrate, inserting the drill guide insert into the guide aperture of the guide tool so that the drill guide insert interfits within the guide rim; and
prior to the step of replacing the guide tool in position against the substrate, removing the drill guide insert from within the guide aperture.

25. The method of claim 21, wherein the electrical insulation socket is an electrical insulation socket of claim 1.

26. The method of claim 21, wherein the guide tool is a guide tool of claim 17.

27. An electrical insulation socket installation kit comprising:
a base portion having an injection aperture extending therethrough to an underside thereof;
at least one body portion comprising a tubular body;
an upper portion comprising a socket opening and a peripheral flange; and
a guide tool comprising:
a substantially-flat underside surface arranged to rest against substrate that the electrical insulation socket is being installed into;
one or more upper surfaces arranged to receive a mass, clamp or other means of restraining the guide tool in position against the substrate;
a guide aperture extending from the underside surface and completely through the guide tool; and
a guide rim, shaped to receive the flange of the electrical insulation socket, recessed into the periphery of the guide aperture on the underside surface.

28. The electrical insulation socket installation kit of claim 27, wherein either: the base portion and one of the at least one body portions are formed together as a base body portion; or
one of the at least one body portions and the upper portion are formed together as an upper body portion;
or both.

29. The electrical insulation socket installation kit of claim 27, further comprising at least one drill guide insert having a drill guide aperture, the drill guide insert being configured to be inserted into the guide aperture of the guide tool from underneath and interfit within the guide rim.

30. The electrical insulation socket installation kit of claim 27, wherein the electrical insulation socket is an electrical insulation socket of claim 1.

31. The electrical insulation socket installation kit of claim 27, wherein the guide tool is a guide tool of claim 17.
